(19) United States
(12) Patent Application Publication
(10) Pub. No.: US 2008/0308378 A1
(43) Pub. Date: Dec. 18, 2008

(54) Coupling device

(75) Inventors: Yuito Abe, Nishio-shi (JP); Yoshihide Mori, Anjo-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/076,925

(22) Filed: Mar. 25, 2008

(30) Foreign Application Priority Data
Jun. 18, 2007 (JP) 2007-160459

(51) Int. Cl. F16D 13/72

(52) U.S. Cl. 192/70.12

(57) ABSTRACT

Cooling oil is fed to a second oil space formed on the inner circumferential side of a hub member, and is also fed through a bypass oil passage to a first oil space formed on the outer circumferential side of a drum member. When the friction plates rotate, with grooves in the friction pads attached to the inner friction plates, the cooling oil flows by inertial force through oil holes in the hub member and through oil holes of the drum member, from the first oil space to the second oil space, and from the second oil space to the first oil space, respectively, through the friction plates. Accordingly, the flow of the cooling oil to the friction plates is improved without notches, etc. in the outer friction plates or in the inner friction plates, resulting in an improvement in cooling of the coupling device.

### INCORPORATION BY REFERENCE

The disclosure of Japanese Patent Application No. JP2007-160459 filed on Jun. 18, 2007 including the specification, drawings and abstract is incorporated herein by reference in its entirety.

### BACKGROUND OF THE INVENTION

1. Field of the Invention

The present invention relates to a coupling device, preferably for use in a vehicle automatic transmission, and, more specifically, to a coupling device in the form of a multi-plate/disc clutch which is slip-controlled and oil cooled.

2. Description of the Related Art

In a vehicle equipped with an automatic transmission, as well as an internal combustion engine as a drive source, when the engine is first started the automatic speed change mechanism and the drive wheels are not rotating although the engine is rotating. Accordingly, a device is required to transmit driving force while minimizing shock due to connection of the non-rotating wheels with the rotating engine. While hydraulic power transmissions such as torque converters have mainly been used as such coupling devices, recently due to, for example, demand for compactness in an automatic transmission, a multi-plate/disc clutch has been proposed for use as a coupling device to transmit driving force while absorbing the above-mentioned difference in rotational speeds, with hydraulic control of its released state, slip state, and engaged state. See, for example, Japanese Patent Application Publication No. JP-A-2004-308894. Because such a starting clutch may remain in a slip state for a prolonged period of time, particularly when a low-speed is maintained during starting, e.g. in parking, a large amount of heat is generated by friction, and therefore, efficient cooling is required to prevent heat seizure of the friction plate. For this reason, in the coupling device disclosed in the above-mentioned Japanese Patent Application Publication No. JP-A-2004-308894, in order to improve cooling efficiency of the friction plates by facilitating circulation of cooling oil, notches are formed in the plates between the plates and the attached pads, the notches serving as passages for cooling oil.

However, as in the case of the clutch of the above-mentioned Japanese Patent Application Publication No. JP-A-2004-308894, the notches in the friction plates create a problem of a lack of strength due to stress concentration in the supporting portion to which the friction pad is attached, and therefore, the thickness of the friction plate must be increased to ensure the requisite strength. However, the solution of an increase in plate thickness, in turn, creates a problem by an increase in the axial dimension of the clutch. In addition, providing a plurality of notches on the friction plate creates the possibility of loss of flatness due to a lack of stiffness of the above-mentioned supporting portions, making control of the slip more difficult and also creates the possibility of generation of so-called hot spots caused by heat concentration, leading to a deterioration in durability.

### SUMMARY OF THE INVENTION

It is an object of the present invention to provide a coupling device with improved cooling without enlargement of the axial dimension, without a loss of controllability, and without loss in durability.

Accordingly, the present invention provides a coupling device for starting a vehicle in motion in the form of a multi-plate/disc clutch interposed between an output shaft of a drive (power) source and an input shaft of an automatic speed change mechanism. The multi-plate/disc clutch is cooled by feeding and discharging cooling oil to and from a case housing the multi-plate/disc clutch. The multi-plate/disc clutch has outer friction plates and inner friction plates alternately arranged, and friction pads attached to either the outer friction plates or the inner friction plates so as to be interposed between outer and inner friction plates, a drum member connected to one of the output shaft of the drive (power) source and the input shaft of the automatic speed change mechanism, and splined to the outer friction plates. The clutch further includes a hub member connected to the other of the output shaft of the drive source and the input shaft of the automatic speed change mechanism, and splined with the inner friction plates. A first oil space is formed on the outer circumferential side of the drum member, and supplied and filled with the cooling oil; and a second oil space is formed on the inner circumferential side of the hub member, and supplied and filled with the cooling oil. The drum member and the hub member have oil holes providing communication between the first oil space and the multi-plate/disc clutch and between the second oil space and the multi-plate/disc clutch, respectively. The friction pads are each formed with grooves including forward inclined grooves that are inclined forward in a direction of rotation relative to the radial direction from the center of the multi-plate/disc clutch, and rearward inclined grooves that are inclined backward in the direction of rotation relative to the radial direction. The friction pads receive the cooling oil from the first oil space and the second oil space, through the oil holes, in their forward inclined grooves and in their rearward inclined grooves.

Accordingly, particularly when the multi-plate/disc clutch is in slipping engagement or fully engaged, it is possible for the cooling oil to flow through the multi-plate/disc clutch, from the first oil space to the second oil space, and from the second oil space to the first oil space. Consequently, the flow of the cooling oil to the friction pads is improved without providing notches, etc. in the outer friction plates or in the inner friction plates. Thus, cooling of the coupling device can be improved without enlargement of the axial dimension and without loss of controllability or durability.

In a preferred embodiment of the present invention, the grooves in the friction pad are formed in a grid pattern. Accordingly, in a simple structure, a plurality of parallel, straight-line grooves are formed intersecting each other, the grooves including the forward inclined grooves and the rearward inclined grooves in the friction pads, and thus, the flow of the cooling oil to the friction pads is improved.

Preferably, the coupling device of the present invention includes a bypass oil passage that bypasses the multi-plate/disc clutch and provides communication between the first oil space and the second oil space, to conduct the cooling oil fed to one of the first oil space and the second oil space to the other.

Accordingly, the cooling oil is fed to both the outer circumferential side and the inner circumferential side of the multi-plate/disc clutch. Consequently, compared to structure in which the cooling oil is fed to only one of the first oil space and the second oil space, temperatures at both the outer and the inner circumferential sides of the clutch can be reduced, and thus, the cooling of the coupling device is further improved.

In addition, the coupling device of the present invention includes a hydraulic actuator which presses the outer and the inner friction plates together in an axial direction with a piston member, wherein the piston member has oil through holes serving as at least a portion of the bypass oil passage. Accordingly, the bypass oil passage can be formed with a simple configuration merely by providing oil through holes in the piston member.

In addition, the coupling device according to the present invention preferably has, in the hub member, oil through holes forming at least a portion of the bypass oil passage. Accordingly, the bypass oil passage can be formed with a simple configuration merely by providing oil through holes in the hub member.

In one preferred embodiment the present invention includes a damper device that is disposed at an axially offset position relative to the first oil space, the multi-plate/disc clutch and the second oil space, and that receives rotation of the drive (power) source, that has been transmitted from the drum member, through the multi-plate/disc clutch, to the hub member and that outputs that rotation to the input shaft of the automatic speed change mechanism, while absorbing vibration. The cooling oil is fed from the inner circumferential side of the second oil space and discharged from the inner circumferential side of the damper device on the axially opposite side of the multi-plate/disc clutch. In other words, the discharge flow of the cooling oil, after cooling the friction plates, is in the axial direction. Consequently, because the cooling oil after cooling the multi-plate/disc clutch need not be held in the first or second oil space, the temperature of the cooling oil in the first and second oil spaces can be reduced, leading to an improvement in the cooling of the coupling device.

### BRIEF DESCRIPTION OF THE DRAWINGS

FIG. 1 is a cross-sectional side view of an embodiment of a coupling device according to the present invention;

FIG. 2 is a rear view showing a friction pad;

FIG. 3 is a cross-sectional side view showing flow of cooling oil in the coupling device; and

FIG. 4 is an enlarged view of the friction pad.

### DETAILED DESCRIPTION OF THE PREFERRED EMBODIMENTS

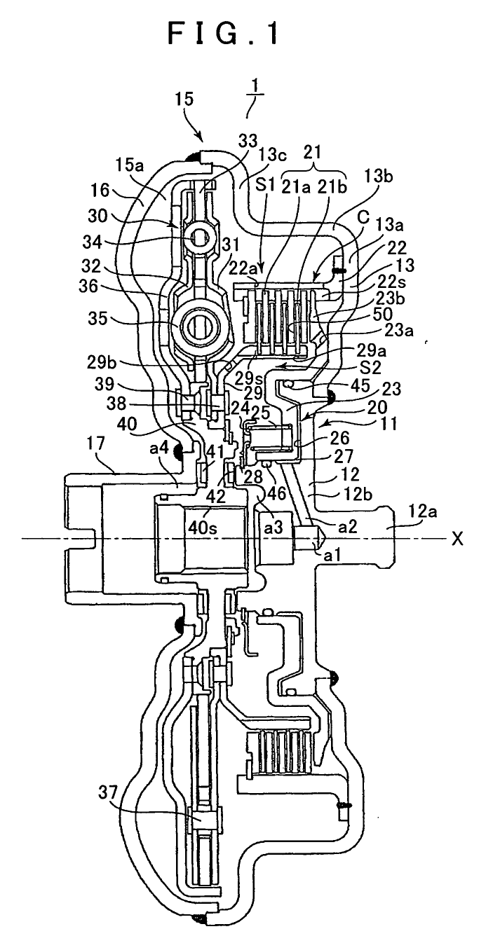

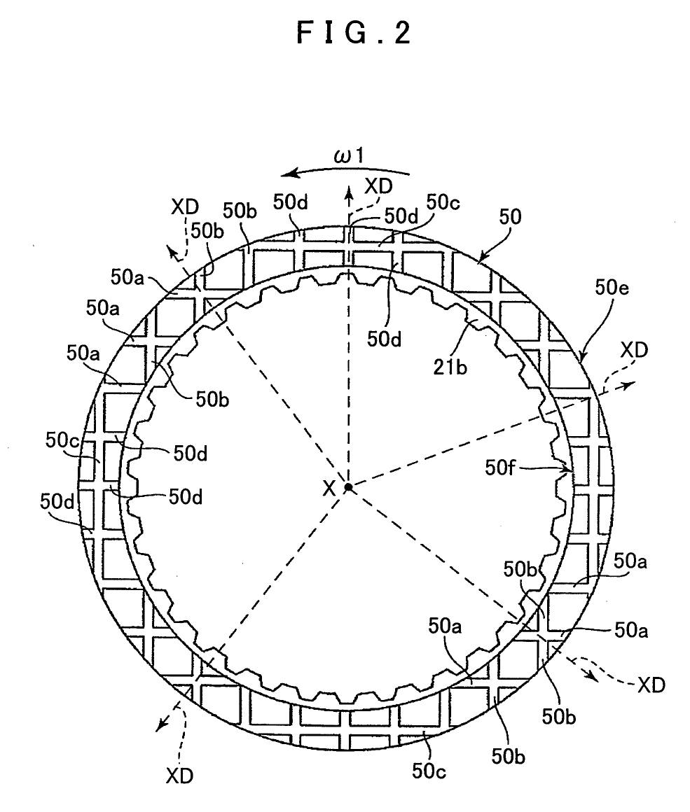

An embodiment according to the present invention will be described below with reference to FIGS. 1 and 2. It should be noted that, in describing the coupling device 1 shown in FIG. 1, it is assumed that the coupling device is longitudinally mounted in an FR (front-engine rear-drive) type vehicle, and that the right side in the drawing is called “front side” and the left side is called “back side” for the purpose of convenience in description. However, the present invention is not so limited and the coupling device may be laterally mounted, for example, in an FF (front-engine front-drive) type vehicle. In other words the coupling device of the present invention may be mounted in any type of vehicle drive train.

The coupling device 1 constitutes an automatic transmission when combined with, for example, an automatic speed change mechanism and a hydraulic control unit, and, as shown in FIG. 1, the coupling device 1 includes an input member 11 connected to an output shaft (crankshaft) of an engine (not shown) and an output member 40 connected to an input shaft (not shown) of an automatic speed change mechanism. The coupling device 1 is housed in a case 15 and includes with a clutch C and a damper 30 in a transmission path connecting the input member 11 with the output member 40.

The input member 11 includes, in a broad sense, a flange member 12 arranged substantially centrally of the front side and a front cover 13 firmly fixed to the outer periphery of the flange member 12. The flange member 12 is formed with a center portion 12a which is fitted to the output shaft of the engine (not shown) and with a flange portion 12b radially extending from center portion 12a.

The front cover 13 includes a front disc portion 13a that is firmly fixed around the periphery of the flange portion 12b to form the front surface of the coupling device 1, an outer cylinder portion 13b that is integral with and bent backward from the front disc portion 13a and a connecting portion 13c that is integral with and extends radially outward from the outer cylinder portion 13b. The connecting portion 13c is firmly fixed to a rear cover 16. In addition, on the front side of the front disc portion 13a of the front cover 13 and in a position determined by the type of engine, there is firmly fixed, for example, a plurality of set blocks (not shown) for adjustment in connecting to the flywheel on the output shaft of the engine. In other words, the front cover 13 is connected to the output shaft of the engine through the set blocks while being axially centered by the center portion 12a of the flange input member 12.

The radially inner circumferential edge of the rear cover 16 is firmly fixed to a hollow sleeve member 17 and the sleeve member 17 is rotatably supported by the transmission case of the automatic speed change mechanism. Taken together, the flange member 12, the front cover 13, the rear cover 16, and the sleeve member 17 constitute the housing case 15 which houses the starting clutch C and the damper device 30 and the whole of the housing case 15 is coupled to the output shaft of the engine so as to rotate in unison with the output rotation of the engine.

Clutch C is located on the back side of the flange member 12 and the front disc portion 13a of the front cover 13, and is radially inward of and axially overlaps with the outer cylinder portion 13b of the front cover 13. The clutch C is a multi-plate/disc clutch 21 including outer friction plates 21a and inner friction plates 21b, a drum member 22 splined with the outer friction plates 21a, a hub member 29 splined with the inner friction plates 21b, and a hydraulic actuator 20 for pressing together the friction plates 21.

The drum member 22 is firmly fixed on its front side to the inner surface of the front cover 13. The inner cylindrical surface of the drum member 22 has splines 22s for spline engagement with the above-mentioned outer friction plates 21a. A first oil space S1, is formed between the outer cylindrical surface of the drum member 22 and the outer cylinder portion 13b of the front cover 13, and is filled with oil (cooling oil). Adjacent the bases of the splines 22s of the drum member 22, there are oil through holes 22a which provide communication between outer and inner sides of the drum member 22. The diameter of the outer cylinder portion 13b of the front cover 13 is set such that the first oil space S1 has an appropriate size relative to the diameter of the drum member 22.

The outer friction plates 21a, engaged by splines 22s of the drum member 22, are arranged alternately with the inner friction plates 21b. The outer friction plates 21a and the inner friction plates 21b constitute the friction plates 21. On both sides of each of the inner friction plates 21b, a friction pad 50 is attached facing an outer friction plate 21a.

As shown in FIG. 2, each of the friction pads 50 is an annular disc, with grooves formed in a grid pattern on the surface facing the outer friction plate 21a. The grid pattern of grooves can be easily formed, for example, by cutting because, it is only necessary to cut one plurality of parallel straight-line grooves intersecting another plurality of cut, parallel straight-line grooves.

The grid pattern of grooves thus formed in the friction pad 50 can be divided into forward inclined grooves 50a, backward inclined grooves 50b, outer circumferential communicating grooves 50c, and radial grooves 50d. That is, each of the forward inclined grooves 50a is a straight line-shaped groove that is inclined forward in the direction of rotation ω1 relative to the radial direction XD extending from the center of rotation X of the clutch C. When the outer friction plates 21a and the inner friction plates 21b engage (contact) each other, due to the rotational inertial force of the oil, the grooves 50A, which present oil receiving openings at the outer circumferential surface 50e of the friction 50 facing forward in the direction of rotation, take in (receive) the oil and conduct the oil to oil discharge openings at the inner circumferential surface 50f of the friction pad 50.

Each of the backward inclined grooves 50b is a straight line (linear) groove that is inclined backward in the direction of rotation ω1 relative to the radial direction XD and also is a groove in which, when the outer friction plates 21a and the inner friction plates 21b engage (contact) due to the rotational inertial force of the oil, an opening on the inner circumferential surface 50f of the friction pad 50 facing forward in the direction of rotation, takes in (receives) the oil and conducts the oil to an oil discharge opening at the outer circumferential surface 50e of the friction pad 50.

Each of the outer circumferential communicating grooves 50c is inclined forward by 90 degrees in the direction of rotation ω1 relative to the radial direction XD. In other words, each groove 50c is parallel to a tangent to the outer circumferential surface 50e. The outer circumferential communicating grooves 50c, when the outer friction plates 21a and the inner friction plates 21b engage (contact) each other, at an oil-receiving opening on the outer circumferential surface 50e facing forward in the direction of rotation, take in (receive) the oil and, by the rotational inertial force of the oil, conduct the oil to oil discharge openings at the outer circumferential surface 50e that is located behind (in the direction of rotation) the oil-receiving opening. Note that in the present description, although the outer circumferential communicating grooves 50c are perpendicular to the radial direction XD, the outer circumferential communicating grooves 50c are defined as forward inclined grooves, for convenience of description, because their openings take in (receive) the oil by facing forward in the direction of rotation ω1 at the outer circumferential surface 50e.

Each of the radial grooves 50d is a straight linear groove that extends substantially in the same direction as the radial direction XD and presents openings, disposed substantially in the radial direction XD, at the outer circumferential surface 50e and at the inner circumferential surface 50f.

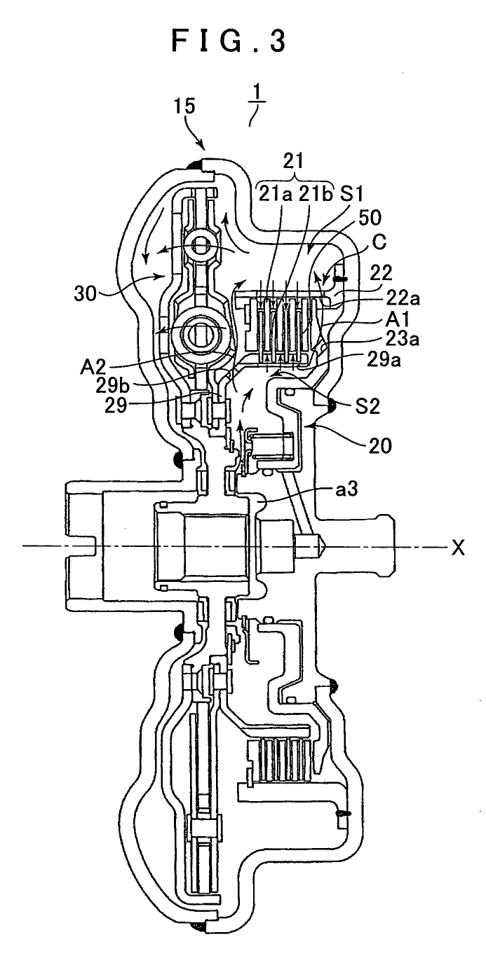

Hub member 29 has a cup shape defining a hollow interior, and is connected at its back side to a drive plate 31 of the damper device 30. The hub member 29 has splines 29s formed on its outer circumferential surface for spline engagement with the inner friction plates 21b. In addition, the hub member 29 axially overlaps the inner friction plates 21b and, in combination with a piston member 23, forms a second oil space S2 which is filled with oil. Adjacent the bases of the spline 29s of the hub member 29, are formed oil through holes 29a which provide oil communication between outer and inner circumferential sides of the hub member 29. Furthermore, between the splined cylindrical portion 29c of the hub member 29 and a connecting portion connecting with the drive plate 31, there are circumferentially arranged plurality of oil through holes 29b forming a bypass oil passage A2 (refer to FIG. 3) that provides oil communication, bypassing the friction plates 21, between the first oil space S1 and the second oil space S2.

The hydraulic actuator 20, located radially inward of friction plates 21, presses the friction plates 21 together with an engaging pressure supplied from the above-mentioned hydraulic control unit, thereby engaging the clutch C. The hydraulic actuator 20 includes a cylinder portion 26 formed in the back face of the flange portion 12b of the flange member 12, the piston member 23, a return plate 24, and a return spring 25. An oil chamber 27 is formed by a seal, i.e., two seal rings 45 and 46, between the cylinder portion 26 and the piston member 23. The oil chamber 27 receives the engaging pressure, 2S regulated by the hydraulic control unit, through oil passages a1 and a2 which are connected to the hydraulic control unit through the input shaft of the automatic speed change mechanism.

The return plate 24 is limited in its backward movement relative to the flange member 12 by a snap ring 28, and the return spring 25 is disposed, under compression, between the return plate 24 and the piston member 23.

The piston member 23 moves to disengage the clutch C responsive to the force of the return spring 25 and to engage responsive to the engaging pressure in the oil chamber 27, and has, at its outer circumference, a pressing portion 23b arranged facing the friction plates 21. The pressing portion 23b is formed with splines on its outer circumferential edge, and the splines are engaged with splines 22s of the drum member 22, whereby the piston member 23 rotates with the same rotation as the output of the engine, together with the drum member 22, the outer friction plates 21a, and the front cover 13. In addition, at a radially inward position on pressing portion 23b is formed a circumferential array of a plurality of through holes 23a, which together function as a bypass oil passage A1 (refer to FIG. 3) that bypasses the friction plates 21 by providing communication between the first oil space S1 and the second oil space S2 in conjunction with oil through holes 22a.

The above-mentioned damper device 30 is arranged on the back side of the clutch C, and includes, two drive plates 31 and 32, a driven plate 33, a connecting plate 36, a damper 34, and a damper 35. The drive plate 31 is fastened by a pin 38 to the hub member 29, which is spline engaged with the inner friction plates 21b of the starting clutch C, and is also fastened to the other drive plate 32 by a pin 37. Drive plates 31 and 32, thus fastened together into a unit, are rotatably positioned and supported on the output member 40, and also sandwich and support the driven plate 33, which is likewise rotatably supported on the output member 40. The driven plate 33 has radially spaced elongated holes which respectively receive the damper 34 including a spring and the damper 35 including a double coil spring.

The outer circumferential edge of the driven plate 33 is spline-fitted to the connecting plate 36 and the inner circumferential edge of the connecting plate 36 is fastened to the output member 40 by a pin 39. The output member 40 is axially positioned and supported relative to the flange member 12 and the sleeve member 17 by thrust bearings 41 and 42, and has splines 40s formed on its inner cylindrical surface which are engaged with splines formed on the input shaft (not shown) of the automatic speed change mechanism and is also fit, at its rear end on the outer circumferential side thereof, to a hollow shaft (not shown) fixed to the transmission case through a socket-and-spigot joint. Thus the output member 40 is not only supported by the hollow shaft and the input shaft of the automatic speed change mechanism, but is also coupled to the input shaft of the automatic speed change mechanism.

In the coupling device 1 described above, when a driving force (rotation) from the engine is transmitted to the input member 11, the front cover 13 and the outer friction plates 21a of the clutch C rotate as a unit with the output shaft of the engine. In addition, in a central portion of the input shaft of the automatic speed change mechanism, there is formed an oil passage connected to the hydraulic control unit of the automatic transmission, and when an engaging pressure for engagement of the starting clutch C is supplied to that oil passage, the engaging pressure is routed to the oil chamber 27 of the hydraulic actuator 20 through the oil passages a1 and a2. When the engaging pressure is supplied from the above-mentioned hydraulic control unit to the oil chamber 27 of the hydraulic actuator 20, the piston member 23 is driven to press backward against the urging force of the return spring 25; that is, the piston member 23 gradually presses the outer friction plates 21a, and inner friction plates 21b together with slipping, thus progressively engaging clutch C. Upon engagement of clutch C the driving rotation from the engine is transmitted to the drive plates 31 and 32 connected to the hub member 29 and from drive plates 31 and 32 to the driven plate 33 while its torque variation is absorbed by the dampers 34 and 35 sandwiched between the drive plates 31, 32. From the driven plate 33 the driving force is transmitted to the input shaft of the automatic speed change mechanism through the output member 40. Then, when the engaging pressure is further increased to completely engage the clutch C, the input member 11 and the output member 40 become substantially united with each other; that is, the output shaft of the engine and the input shaft of the automatic speed change mechanism are substantially directly connected with each other. When the engaging pressure of the oil chamber 27 is drained (discharged), the piston member 23 is moved back to the front side by return spring 25 and clutch C is released. In a manner similar to, for example, the creep state of an automatic transmission provided with a torque converter, the clutch C is also brought into a slip state during running in a congested area (with repeated starts and stops) and in a parking mode, and therefore, there are cases in which the starting clutch C is left in a slip state for a long period of time. In those cases, a great amount of heat is generated by the friction plates 21.

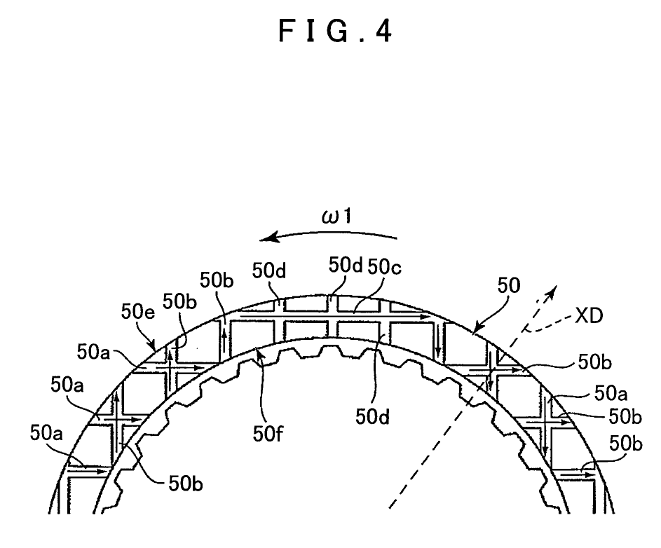

Next, cooling of the friction plates 21, which is a main function of the present invention, will be described with reference to FIGS. 3 and 4.

Between the hollow shaft and the input shaft of the automatic speed change mechanism mentioned above, is formed an oil passage connected to the hydraulic control unit and in communication with an internal space 15a within the housing case 15, through the inner circumferential side of the output member 40 (having spline 40s) and through an oil passage a3 (refer to FIG. 1). That is, when oil is supplied from the oil passage between the hollow shaft and the input shaft of the automatic speed change mechanism the oil enters the internal space 15a through the oil passage a3.

In other words, as shown in FIG. 3, when the oil flows from the oil passage a3 through the thrust bearing 42, it then enters the second oil space S2, and is also fed to the first oil space S1 on the outer circumferential side of the clutch C, through the bypass oil passage A2, which includes the through holes 29b of the hub member 29, and through the bypass oil passage A1, which includes the through holes 23a in the piston member 23. The oil fed to the first oil space S1 and the second oil space S2 is conducted to the inner and outer circumferential sides of the friction plates 21 through the oil holes 22a in the drum member 22 and through the oil holes 29a in the hub member 29.

Then, as shown in FIG. 4, with the above-mentioned forward inclined grooves 50a in the friction pads 50, when the friction plates 21 rotate in the direction ω1, the oil that has been retained in the forward inclined grooves 50a flows by inertial force in the direction indicated by the arrows (that is, from the outer circumferential side to the inner circumferential side) and, thus, the oil on the outer circumferential side of the friction plate 21, that is, the oil in the above-mentioned first oil space S1, is received by the forward inclined grooves 50a and is discharged to the inner circumferential side of the friction plates 21, that is, to the second oil space S2. Also when the friction plates 21 rotate in the direction ω1, the outer circumferential communicating grooves 50c receive the oil from the outer circumferential side and discharge the oil to the back side in the direction of rotation ω1 on the outer circumferential side of friction plates 21.

Regarding the backward inclined grooves 50b in the friction pads 50, when the friction plates 21 rotate in the direction ω1, the oil that has been retained in the backward inclined grooves 50b flows by inertial force in the direction indicated by the arrows (that is, from the inner circumferential side to the outer circumferential side); thus, the oil on the inner circumferential side of the friction plates 21, that is, the oil in the above-mentioned second oil space S2, is received by the backward inclined grooves 50b, and is discharged to the outer circumferential side of the friction plates 21, that is, to the first oil space S1.

Accordingly as shown in FIG. 3, there is established a flow pattern in which the oil supplied from the hydraulic control unit to the first oil space S1 and to the second oil space S2 moves from the outer circumferential side to the inner circumferential side of the friction plates 21, and from the inner circumferential side to the outer circumferential side of the friction plates 21, passing through grooves in the pads 50 on the friction plates 21. A flow of oil is thereby established which is highly effective in cooling the friction plates 21.

It should be noted that, in the radial grooves 50d of the friction pad 50 shown in FIG. 4, even when the friction plates 21 rotate in the direction ω1, the movement of the oil is small even though a centrifugal force acts on the oil in the radial grooves 50d, because a centrifugal oil pressure is generated in the first oil space S1 on the outer circumferential side. However, because the outer circumferential communicating grooves 50c have openings positioned at openings of the radial grooves 50d, the friction plates 21 are cooled by the oil moving through the outer circumferential communicating grooves 50c, even in a state in which the movement of oil through the radial grooves 50d is small; thus, generation of hot spots is prevented.

The oil that has thus cooled and lubricated the friction plates 21 flows from the first oil space S1 and the second oil space S2, then passes through the outer circumferential side and through the inside of the damper device 30, thus cooling and lubricating the damper device 30, and then flows to the back side of the damper device 30, as shown in FIG. 3. The oil that has routed to the back side of the damper device 30 flows to the inner circumferential side, is then discharged through the thrust bearing 41 to an oil passage a4 formed between the hollow shaft and the sleeve member 17, and is conducted to an oil pan provided below the above-mentioned hydraulic control unit. The hydraulic control unit is connected to an unshown oil cooler, and thus the oil that has been warmed in the above-described cooling of the friction plates and damper is returned after having its temperature reduced by the oil cooler.

As described above, in the present embodiment of the coupling device 1, cooling oil is supplied both to the first oil space S1 on the outer circumferential side of the drum member 22 and to the second oil space S2 on the inner circumferential side of the hub member 29. The oil holes 22a and 29a in the drum member 22 and the hub member 29 provide for oil flow between the first oil space S1 and the friction plates 21 and between the second oil space S2 and the friction plates 21, respectively. When the outer friction plates 21a or the inner friction plates 21b carrying the friction pads 50 rotate, the forward inclined grooves 50a receive the cooling oil from the first oil space S1 on the outer circumferential side while the backward inclined grooves 50b receive the cooling oil from the second oil space S2 on the inner circumferential side. Therefore, particularly when the friction plates 21 are in slipping engagement or fully engaged, the coupling device 1 can establish flows of the cooling oil flow from the first oil space S1 to the second oil space S2, and from the second oil space S2 to the first oil space S1 so that the cooling oil passes through the friction plates 21. Consequently, the flow of the cooling oil to the friction pads 50 is improved without providing notches or the like in the outer friction plates or in the inner friction plates; that is, cooling of the coupling device 1 is improved without enlargement of the axial dimension, loss of controllability, reduction in durability, or the like.

In addition, because the grooves in the friction pads 50 are formed in a grid pattern, by a simple structure in which merely a plurality of parallel straight-line grooves are formed in two directions intersecting each other, i.e. the forward inclined grooves 50a and the backward inclined grooves 50b, the present invention provides an improved flow of the cooling oil to the friction pads 50.

In addition, because the bypass oil passages A1 and A2 conduct the cooling oil fed to one of the first oil space S1 and the second oil space S2 to the other, while bypassing the friction plates 21, the cooling oil fed to both the outer circumferential side and the inner circumferential side of the friction plate 21 can be utilized for cooling. Consequently, compared with the case in which the cooling oil is fed to only one of the first oil space S1 and the second oil space S2, temperatures at both the outer and the inner circumferential sides can be reduced, and thus, the cooling of the coupling device 1 is further improved.

The bypass oil passage A1 has a simple configuration consisting of merely the oil holes 23a formed in the piston member 23.

Likewise, the bypass oil passage A2 has a simple configuration consisting of merely the oil holes 29b formed in the hub member 29.

Furthermore, because the cooling oil is fed from the inner circumferential side of the second oil space S2 and discharged from the inner circumferential side of the damper device 30, axially opposite side of the friction plates 21, the result is a flow path in the axial direction for discharge of the cooling oil after cooling the friction plates 21. Consequently, because the cooling oil after cooling the friction plates 21 is not retained in the first oil space S1 or in the second oil space S2, the temperature of the cooling oil in the first oil space S1 and the second oil space S2 can be reduced, leading to an improvement in the cooling of the coupling device 1.

Note that, although the present embodiment describes a structure in which the grooves shapes are arranged in a grid pattern including the radial grooves 50d, the groove pattern may be a plurality of V-shapes. Thus, the present invention includes any pattern of grooves in the friction plates, provided the pattern includes both forward inclined grooves and backward inclined grooves.

In addition, although the present embodiment describes a structure in which the cooling oil flows from the inner circumferential side of the clutch C, then passes through the clutch C and the damper device 30, and flows to the inner circumferential side of the damper device 30 through its back face side, the present invention is applicable even in the case, for example, wherein the cooling oil is fed from the inner circumferential portion on the back face side of the damper device 30, then passes through the damper device 30 and the clutch C, and flows to the inner circumferential side of the clutch C. Thus, the present invention is also applicable to a case wherein the cooling oil flows in a reverse direction.

Moreover, although the present embodiment describes a structure in which, for example, the drum member 22 is firmly fixed to the front cover 13 and the hub member 29 is connected to the damper device 30, the drum member may be connected to the damper device and the hub member fixed to the front cover. Thus, the present invention is applicable to any coupling device, provided one of the drum member and the hub member is connected to an output shaft of a driving source and the other one is connected to an input shaft of an automatic speed change mechanism.

The coupling device of the present invention can be used for an automatic transmission mounted in a passenger vehicle, a truck, a bus, an agricultural machine, and so on, and is particularly useful where compactness of a coupling device and an improvement in the cooling of friction brake or clutch pads are required, without enlargement of the axial dimension, without loss of controllability, and without any reduction in the durability of the coupling device.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A coupling device for controlling starting of a vehicle in motion by controlling engagement of a multi-plate/disc clutch, interposed between an output shaft of a drive source and an input shaft of an automatic speed change mechanism, and in which the multi-plate/disc clutch is cooled by feeding and discharging cooling oil to and from a case housing the multi-plate/disc clutch, wherein the coupling device comprises:
outer friction plates and inner friction plates alternately arranged;
friction pads attached to one of the outer friction plates and the inner friction plates so as to be interposed between adjacent outer and inner friction plates,
a drum member connected to one of the output shaft of the drive source and the input shaft of the automatic speed change mechanism, and engaged through a spline connection with the outer friction plates;
a hub member connected to the other of the output shaft of the drive source and the input shaft of the automatic speed change mechanism, and splined to the inner friction plates;
a first oil space, on the outer circumferential side of the drum member, for receiving the cooling oil; and
a second oil space, on the inner circumferential side of the hub member, for receiving the cooling oil; and
wherein the drum member and the hub member have oil holes extending therethrough and providing communication between the first oil space and the multi-plate/disc clutch and between the second oil space and the multi-plate/disc clutch, respectively,
wherein, the friction pads have a plurality of grooves including forward inclined grooves that are inclined forward in a direction of rotation relative to a radius extending from a center of the hub member, and backward inclined grooves that are inclined backward in the direction of rotation relative to the radius, and
wherein the friction pads, through the oil holes, receive the cooling oil from the first oil space and the second oil space in the forward inclined grooves and in the backward inclined grooves, respectively.

2. The coupling device according to claim 1, wherein the forward inclined grooves and the backward inclined grooves intersect in a grid pattern.

3. The coupling device according to claim 2, further comprising a bypass oil passage that provides oil communication between the first oil space and the second oil space and flow of the cooling oil fed from one of the first and second oil spaces to the other of the first and second oil spaces, which flow bypasses the inner and outer friction plates.

4. The coupling device according to claim 3, further comprising a hydraulic actuator with a piston for pressing the outer and inner friction plates together and wherein the bypass oil passage comprises oil holes through the piston member.

5. The coupling device according to claim 4, wherein the bypass oil passage further comprises oil holes in the hub member.

6. The coupling device according to claim 5, further comprising a damper device that is disposed at a position axially offset from the first oil space, the outer and inner friction plates and the second oil space, and that transmits rotation of the drive source, received from the hub member by engagement between the inner and outer friction plates to the input shaft of the automatic speed change mechanism while absorbing vibration, wherein
the cooling oil is fed from the inner circumferential side of the second oil space and discharged at the side of the damper device axially opposite the inner and outer friction plates.

7. The coupling device according to claim 2, further comprising a damper device that is disposed at a position axially offset from the first oil space, the outer and inner friction plates and the second oil space, and that transmits rotation of the drive source, received from the hub member by engagement between the inner and outer friction plates to the input shaft of the automatic speed change mechanism while absorbing vibration, wherein
the cooling oil is fed from the inner circumferential side of the second oil space and discharged at the side of the damper device axially opposite the inner and outer friction plates.

8. The coupling device according to claim 3, wherein the bypass oil passage comprises oil holes in the hub member.

9. The coupling device according to claim 3, further comprising a damper device that is disposed at a position axially offset from the first oil space, the outer and inner friction plates and the second oil space, and that transmits rotation of the drive source, received from the hub member by engagement between the inner and outer friction plates to the input shaft of the automatic speed change mechanism while absorbing vibration, wherein
the cooling oil is fed from the inner circumferential side of the second oil space and discharged at the side of the damper device axially opposite the inner and outer friction plates.

10. The coupling device according to claim 8, further comprising a damper device that is disposed at a position axially offset from the first oil space, the outer and inner friction plates and the second oil space, and that transmits rotation of the drive source, received from the hub member by engagement between the inner and outer friction plates to the input shaft of the automatic speed change mechanism while absorbing vibration, wherein
the cooling oil is fed from the inner circumferential side of the second oil space and discharged at the side of the damper device axially opposite the inner and outer friction plates.

11. The coupling device according to claim 4, further comprising a damper device that is disposed at a position axially offset from the first oil space, the outer and inner friction plates and the second oil space, and that transmits rotation of the drive source, received from the hub member by engagement between the inner and outer friction plates to the input shaft of the automatic speed change mechanism while absorbing vibration, wherein
the cooling oil is fed from the inner circumferential side of the second oil space and discharged at the side of the damper device axially opposite the inner and outer friction plates.

12. The coupling device according to claim 1, further comprising a bypass oil passage that bypasses the outer and inner friction plates and provides communication between the first oil space and the second oil space and flow of the cooling oil fed from one of the first oil space and the second oil space to the other.

13. The coupling device according to claim 12, further comprising a hydraulic actuator with a piston for pressing the outer friction plates and the inner friction plates together, and wherein the bypass oil passage comprises oil through holes in the piston.

14. The coupling device according to claim 13, wherein the bypass oil passage further comprises oil holes in the hub member.

15. The coupling device according to claim 13, further comprising a damper device that is disposed at a position axially offset from the first oil space, the outer and inner friction plates and the second oil space, and that transmits rotation of the drive source, received from the hub member by engagement between the inner and outer friction plates to the input shaft of the automatic speed change mechanism while absorbing vibration, wherein
the cooling oil is fed from the inner circumferential side of the second oil space and discharged at the side of the damper device axially opposite the inner and outer friction plates.

16. The coupling device according to claim 14, further comprising a damper device that is disposed at a position axially offset from the first oil space, the outer and inner friction plates and the second oil space, and that transmits rotation of the drive source, received from the hub member by engagement between the inner and outer friction plates to the input shaft of the automatic speed change mechanism while absorbing vibration, wherein
the cooling oil is fed from the inner circumferential side of the second oil space and discharged at the side of the damper device axially opposite the inner and outer friction plates.

17. The coupling device according to claim 12, wherein the bypass oil passage comprises oil holes in the hub member.

18. The coupling device according to claim 17, further comprising a damper device that is disposed at a position axially offset from the first oil space, the outer and inner friction plates and the second oil space, and that transmits rotation of the drive source, received from the hub member by engagement between the inner and outer friction plates to the input shaft of the automatic speed change mechanism while absorbing vibration, wherein
the cooling oil is fed from the inner circumferential side of the second oil space and discharged at the side of the damper device axially opposite the inner and outer friction plates.

19. The coupling device according to claim 1, further comprising a damper device that is disposed at a position axially offset from the first oil space, the outer and inner friction plates and the second oil space, and that transmits rotation of the drive source, received from the hub member by engagement between the inner and outer friction plates to the input shaft of the automatic speed change mechanism while absorbing vibration, wherein
the cooling oil is fed from the inner circumferential side of the second oil space and discharged at the side of the damper device axially opposite the inner and outer friction plates.
